(19) United States
(12) Patent Application Publication
(10) Pub. No.: US 2008/0034077 A1
(43) Pub. Date: Feb. 7, 2008

(54) Operation management method, operation management program, operation management system and operation management apparatus

(76) Inventors: Soichi Takashige, Yokohama (JP); Kazuhide Aikoh, Yokohama (JP); Shigeru Miyake, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/544,638

(22) Filed: Oct. 10, 2006

(30) Foreign Application Priority Data
Aug. 1, 2006 (JP) 2006-209465

(51) Int. Cl. G06F 15/177; G06F 15/173

(52) U.S. Cl. 709/223; 709/220

(57) ABSTRACT

An operation management method wherein a storage device stores a plurality of pieces of first allocation information representative of a correspondence among at least business or service, network segments and logical addresses of networks, and when an instruction of setup for at least business or service provided by each managed computer is received from an external, an operation management apparatus generates a correspondence between the plurality of pieces of first allocation information and a plurality of pieces of second allocation information representative of a correspondence between the managed computers and a physical address of each of network connections. When a system configuration is changed, an operation object can be designated by using information such as business without depending upon a hardware structure.

### BACKGROUND OF THE INVENTION

1. Field of the Invention

The present invention relates to an operation management method, an operation management program, an operation management system and an operation management apparatus.

2. Description of the Related Art

In an environment having a number of servers and operating a number of business programs on each server, introducing new services in a short term and changing types of business and service contents are frequently performed. It is therefore required to configure a new system environment quickly and re-configure the already configured server environment. Particularly in recent years, there is a high need for changing application fields of a server under operation. By flexibly changing application fields of a server, a server usage factor can be improved. For example, on-line may be used in day times whereas batch may be used in night times.

When a hardware failure or the like occurs in a server, it is necessary to replace the server with a new one and recover the environment.

However, configuration of a system providing business and a change in the business provided by the system are often associated with many cases in which a number of settings are required to be input and changes are required. For example, there occur introduction, replacement and the like of an operating system (OS) and a business program. Conventional technology generally uses a system in which a dedicated agent is provided to dynamically acquire and reflect settings of an application stored in an external repository server, as described in U.S. Pat. No. 6,725,261, or generally uses a disk image deploy process. In a deploy process, a plurality of disk images storing OS, business programs and business files are prepared beforehand, and an operation administrator selects a disk image when necessary and copies it in a predetermined server.

In the deploy process, it is necessary to set network setting information corresponding to business, e.g., a server network address, to a network card (network interface) corresponding to the business.

As a method of setting a network address, JP-A-2004-120040 describes techniques that template information defining in advance features of a fundamental system is prepared, and information on the number of servers for each type of the system and sub-nets connecting the servers is input to generate a network setting file describing network setting information including the number of servers.

A method is known by which network setting information is set by a dynamic host configuration protocol (DHCP) server or the like in accordance with a rule registering in advance network cards and IP addresses.

### SUMMARY OF THE INVENTION

With the method using the DHCP server, however, when a server changes business, it becomes necessary to set again the network setting information corresponding to the business to the DHCP server.

As described in JP-A-10-133860, a system having a plurality of general servers of similar software structures can be re-configured by distributing a disk image to each server.

It is necessary, however, to set network setting information such as an IP address as many times as the number of servers.

Japanese Patent No. 3707728 describes that a network address is assigned uniquely to each network interface. However, it does not explicitly describe the management method. It is therefore necessary that when application fields of a server is changed, an administrator assigns a network address corresponding to the new business.

If two or more network cards are mounted on a server, an interface of a logical network card corresponding to the physical network card is generated in the card recognition order by an operating system (OS) of the server. A correspondence between physical and logical network cards is dependent upon OS and the hardware structure of the server.

If two or more network cards are mounted on a server, JP-A-2004-120040 cannot assign a specific network address to a specific physical network card. Namely, since a network address is assigned to an interface of a logical network card, integrity cannot be ensured even if a specific network address is assigned to a specific physical network card. Therefore, an operation administrator refers to a network address assigned to an interface of a logical network card, an identification number of a physical network card and information on a network segment to set the network addresses manually. Particularly in operations in which business of each server is frequently changed and a network segment is divided into virtual networks by a method such as VLAN, settings are complicated and at the same time there is a high possibility of misses at work.

It is an object of the present invention to solve the above-described conventional problems and reduce a work load of an operation administrator considerably when a system is configured or the configuration of the system is changed.

It is another object of the present invention to suppress system setting misses by an operation administrator.

According to one aspect of the present invention, there is provided an operation management method for an operation management system including a plurality of managed computers having a plurality of network connections and an operation management apparatus for managing said managed computers, wherein:

said operation management apparatus stores a plurality of pieces of first allocation information representative of a correspondence among at least business or service, network segments and logical addresses of networks, in a storage device; and

when an instruction of setup for at least business or service provided by each managed computer is received from an external,
said operation management apparatus generates a correspondence between said plurality of pieces of first allocation information and a plurality of pieces of second allocation information representative of a correspondence between said managed computers and a physical address of each of said network connections.

According to an aspect of the present invention, network setting information generated in accordance with a rule, which includes a business name, a LAN segment, and address information which relates to an IP address, registered beforehand independently from a hardware structure on the basis of the business viewpoint is set to a network card of a server desired by an operation administrator.

It is possible reduce a work load of an operation administrator considerably when a system is configured or the configuration of the system is changed.

It is possible to suppress system setting misses by an operation administrator.

### BRIEF DESCRIPTION OF THE DRAWINGS

FIG. 1 is a diagram showing an example of the overall configuration of an operation management system according to a first embodiment of the present invention.

FIG. 2 is a diagram showing an example of a functional structure of a server management server of the operation management system of the first embodiment of the present invention.

FIG. 3 is a diagram showing an example of a functional structure of a network allocation server of the operation management system of the first embodiment of the present invention.

FIG. 4 is a diagram showing an example of a functional structure of a managed server of the operation management system of the first embodiment of the present invention.

FIG. 5 is a diagram showing an example of a structure of an allocation rule table provided in the server management server of the first embodiment of the present invention.

FIG. 6 is a diagram showing an example of a structure of a service list table provided in the server management server of the first embodiment of the present invention.

FIG. 7 is a diagram showing an example of a structure of a server list table provided in the server management server of the first embodiment of the present invention.

FIG. 8 is a diagram showing an example of a structure of a VLAN list table provided in the server management server of the first embodiment of the present invention.

FIGS. 9A and 9B are diagrams showing examples of a structure of a network allocation table provided in the network allocation server of the first embodiment of the present invention (FIG. 9A shows the table for VLAN 1, and FIG. 9B shows the table for VLAN 2).

FIG. 10 is a diagram showing an example of a flow illustrating a process of initializing tables stored in a storage device, to be executed by a processing unit of the server management server of the first embodiment of the present invention.

FIG. 11 is a diagram showing an example of a flow illustrating a process of setting up the managed server, including automatic assignment of an IP address, to be executed by a processing unit of the server management server of the first embodiment of the present invention.

FIG. 12 is a diagram showing an example of a flow illustrating a process to be executed by a network setting acquisition unit of the managed server of the first embodiment of the present invention.

FIG. 13 is a diagram showing an example of a flow illustrating a process to be executed by a network setting assignment unit in a processing unit of the network allocation server of the first embodiment of the present invention.

FIG. 14 is a diagram showing an example of a flow illustrating a process of registering information received from the server management server in the network allocation table, to be executed by the processing unit of the network allocation server of the first embodiment of the present invention.

FIG. 15 is a diagram showing an example of a flow illustrating a process to be executed by a disk image deploy processing unit of the managed server of the first embodiment of the present invention.

FIG. 16 is a diagram showing an example of a time chart of the operation management system of the first embodiment of the present invention.

FIG. 17 is a diagram showing an example of an overall configuration of an operation management system according to a second embodiment of the present invention.

### DESCRIPTION OF THE EMBODIMENT

### First Embodiment

With reference to the accompanying drawings, description will be made on the first embodiment of the present invention (operation management method, operation management program, operation management system and operation management apparatus).

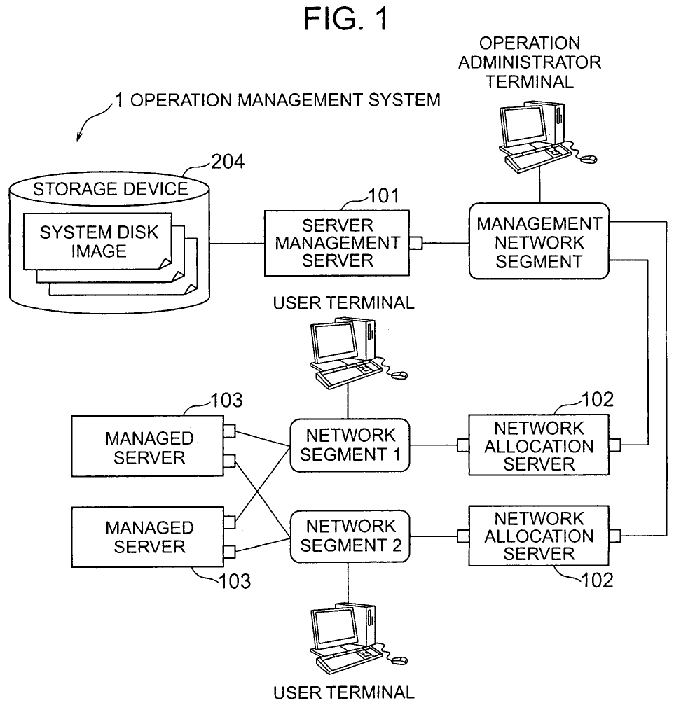

FIG. 1 is a diagram showing an example of the configuration of an operation management system 1 according to the first embodiment of the present invention. As shown in FIG. 1, the operation management system 1 is constituted of a server management server 101, at least one network allocation server 102 and at least one managed server 103.

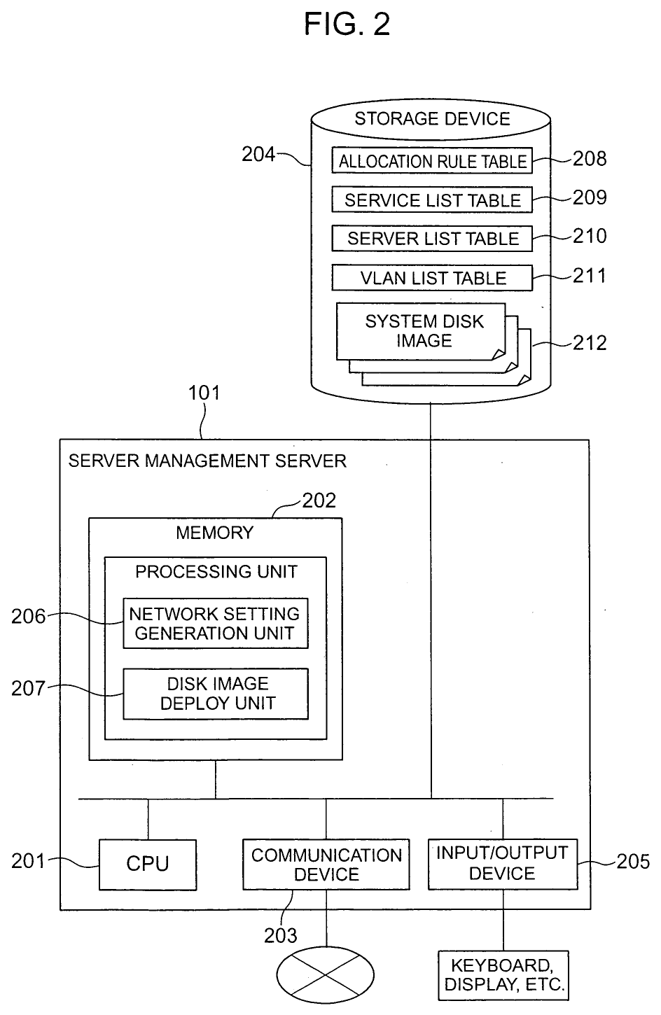

The server management server 101 has a storage device (204 in FIG. 2) to be described later, the storage device storing system disk images. The server management server manages a table to be described later to assign an IP address to a network card mounted on the managed server 103, generates network setting information of the managed server, and deploys the managed server 103 by using the system disk image.

The network allocation server 102 assigns an IP address to the network card mounted on the managed server 103. The managed server 103 is a computer for supplying business/services determined from business and services. The server management server 101 of the first embodiment manages the managed servers 103. Services are in charge of part of business, and correspond to, for example, a Web server and an AP server.

In this configuration, the server management server 101 and network allocation server 102 are interconnected by a management network segment, and the network allocation server 102 and managed server 103 are interconnected by a network segment N. The managed server 103 belongs to a plurality of network segments N and connected to each network allocation server 102 via each network segment N.

An operation administrator terminal is connected to the management network segment. An operation administrator can perform operation management by transmitting a message to the server management server 101 from the operation administrator terminal.

A user terminal is connected to each network segment to perform business or the like.

In the following description, an IP address is used as an example of network setting information and a VLAN is used as an example of the network segment N.

FIG. 2 is a block diagram showing an example of the functional structure of the server management server 101 shown in FIG. 1. The server management server 101 is constituted of a CPU 201, a memory 202, a communication device 203, a storage device 204 and an input/output device 205. The memory 202 is loaded with programs for a network setting generation unit 206 and a disk image deploy unit 207 both serving as a processing unit, and the programs are executed by CPU 201. The storage unit 204 stores an allocation rule table 208, a service list table 209, a server list table 210, a VLAN list table 211 and system disk images 212. The storage device 204 is a storage device installed inside or outside the server management server 101.

Each system disk image 212 is a copy of the contents of a storage device 404 of the managed server 103, the contents setting up an operating system and application software necessary for supplying business/services determined from business and services. The copied contents are stored as a file of the server management server 101.

The managed server 103 can supply business/services in accordance with the contents of the system disk image 212, by writing the system disk image 212 in the storage device 404 of the managed server 103. The server management server 101 refers to a storage address of the system disk image in the service list table 209 by using a business name and a service name designated by the operation administrator, and acquires the system disk image at the storage address.

The system disk image 212 is registered by storing the contents (image) of the storage device of the managed server 103 set up beforehand by an initial configuration work in the storage device 204 of the server management server 101 by using a dedicated backup program (not shown), and by storing the storage address of the contents in a disk image 603 of the service list table 209 to be described later (refer to FIG. 6). A business name 601 and a service name 602 are registered by explicit designation by the operation administrator when the contents are stored in the disk image 603, for example, by using a GUI of the backup program.

Another registration method may be adopted. For example, a program list of programs existing in the contents (disk image) of the storage device 404 of the managed server 103 and corresponding business name and service name are stored beforehand and separately in a file. After the contents (disk image) of the storage device 404 of the managed server 103 are backed up by using a dedicated backup program (not shown), a program name is read from the backup contents (disk image). This program name is compared with the program list and when both the names are coincident, the business name and service name corresponding to the program list are determined. The storage address of the backup contents (disk image) and the determined business name and service name are automatically registered in the service list table 209.

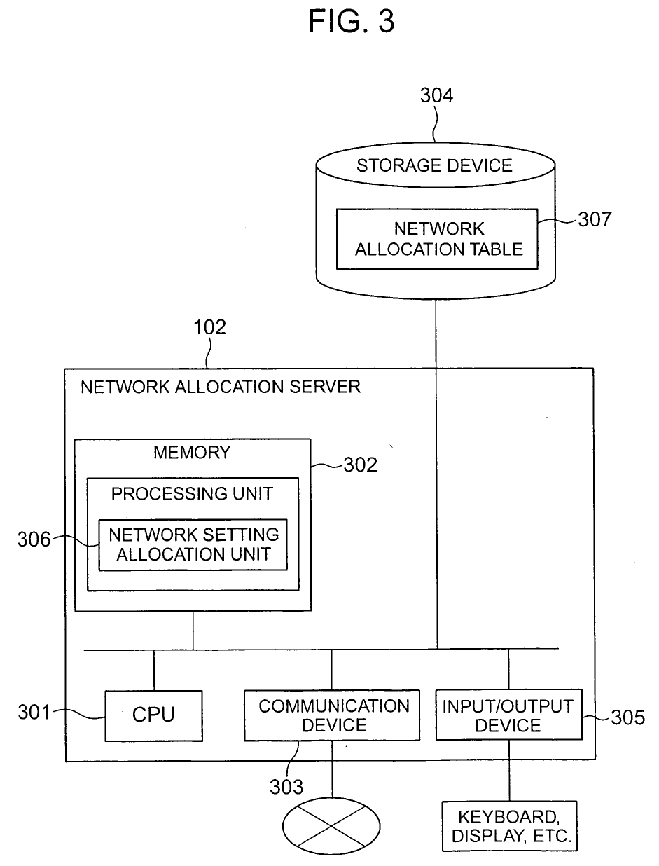

FIG. 3 is a block diagram showing an example of the functional structure of the network allocation server 102 shown in FIG. 1. The network allocation server 102 is constituted of a CPU 301, a memory 302, a communication device 303, a storage device 304 and an input/output device 305. The memory 302 is loaded with a program for a network setting allocation unit 306, and this program is executed by CPU 301. The storage device 304 stores a network setting allocation table 307.

An example of the network allocation server 102 is a DHCP server or the like. In the first embodiment, it is assumed that a general DHCP server is mounted.

In the first embodiment, although the network allocation server 102 is implemented by a computer different from the server management server 101, programs of both the servers may be executed in the same computer. If the network allocation server 102 is implemented by a different program on the same computer as the server management server 101, a single network allocation server 102 assigns network addresses to a plurality of VLANs. If a single network allocation server 102 assigns network addresses to a plurality of VLANs, the network allocation server 102 has network allocation tables 307 different for each identification number of the network card in the server management server 101.

The server management server 101 and network allocation server 102 may be implemented by the same program.

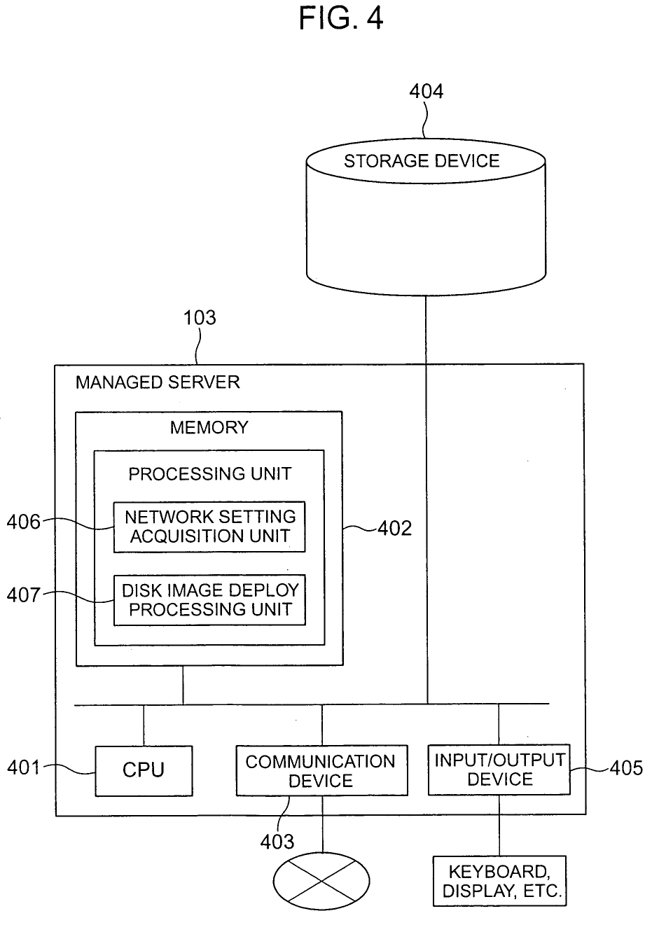

FIG. 4 is a block diagram showing an example of the functional structure of the managed server 103 shown in FIG. 4. An example of the managed server 103 is a general computer system. The managed server 103 is constituted of a CPU 401, a memory 402, a communication device 403, a storage device 404 and an input/output device 405. The memory 402 is loaded with programs for a network setting acquisition unit 406 and a disk image deploy processing unit 407, and these programs are executed by CPU 401.

An example of the managed server 103 is a blade server having a plurality of computers accommodated in one chassis. In a blade server, a number of servers accommodated in one chassis are connected to at least one network switch accommodated in the chassis. At least one blade server is assigned a server name unique to each chassis, and the server management server 101 supplies operation management to assign an IP address to a network interface of the blade server. The blade servers in the chassis can supply the same business/services or a plurality of business/services, and can operate by separating the network interface for each business/service. In systems using the blade servers, some system has several hundred managed servers. In the business system of the first embodiment, ten to several ten types of business are operated typically. Application fields of the managed server are periodically changed between types of business to flexibly use the managed server and improve the server usage efficiency. In this case, since the number of times of changing a network address setting depends on the number of types of business and the number of servers, it may be required to change tens of network addresses at a time in the environment described above. Since the change occurs periodically, the work cost is incurred continuously.

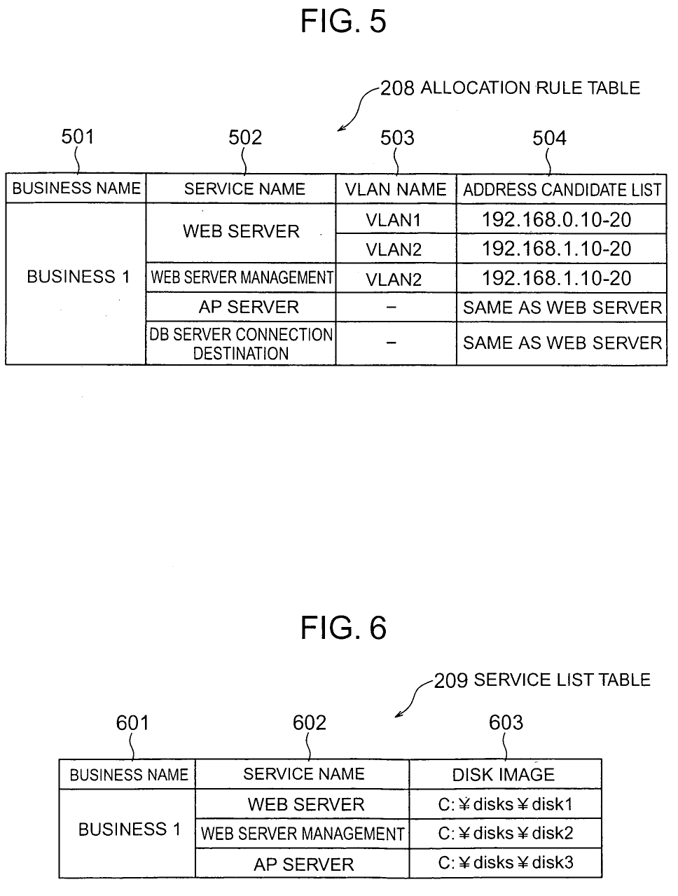

FIG. 5 is a diagram showing an example of the structure of the allocation rule table 208 which defines the proper range of IP addresses which the server management server 101 of the operation management system of the first embodiment shown in FIG. 1 assigns to the managed servers 103.

The allocation rule table 208 are constituted of fields for a business name 501, a service name 502 and a VLAN name 503 which are conditions for determining an allocation rule, and an IP address candidate list 504 to be identified by these conditions. The address candidate list 504 is constituted of a list of at least one IP address capable of being assigned to the server identified, for example, by the above-described conditions. Alternatively, a plurality of consecutive IP addresses may be represented by one range, or IP addresses generated by a predetermined rule, such as 192.168.0.1, 192.168.0.11 and 192.168.0.20 may be described by a generation rule 192.168.0. (10*n+1) (n=0, 1, 2, . . . ).

As an example of the method of generating the allocation rule table 208, at the time of initial system configuration, an operation administrator updates the allocation rule table 208 registered in the storage device 204 via GUI or directly for explicit registration.

In an alternative method, when the allocation rule table 208 is registered, a combination of the business name 501 and service name 502 is acquired from a business name 601 and a service name 602 of a service list table 209 to be described later, and the operation administrator inputs the VLAN name 503 and address candidate list 504 for each acquired combination.

FIG. 6 is a diagram showing an example of the structure of the service list table 209 to be used for identifying a disk image from the business name and service name, the disk image being deployed for the managed server 103 by the server management server 101 of the operation management system 1 of the first embodiment shown in FIG. 1.

The service list table 209 is constituted of fields for a business name 601, a service name 602 and a disk image 603. The disk image 603 is an identifier for uniquely identifying the system disk image 212 (refer to FIG. 2) and described by a file path name of the system disk image.

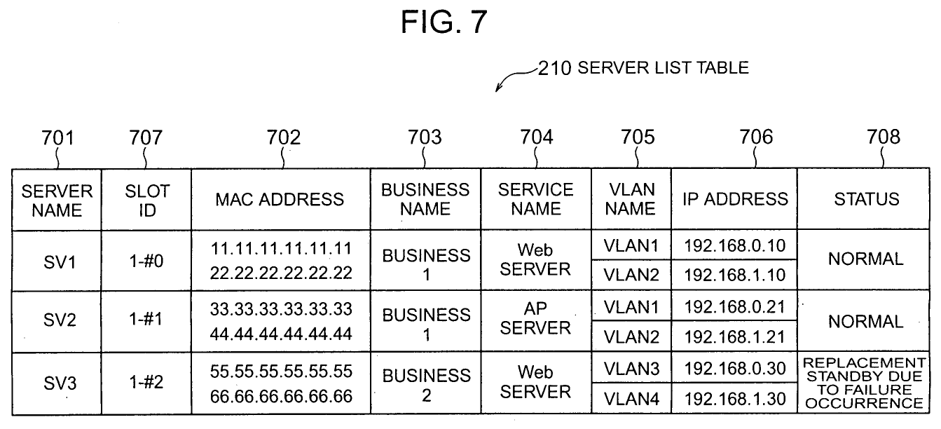

FIG. 7 is a diagram showing an example of the server list table 210 provided in the server management server 101 of the operation management system 1 of the first embodiment shown in FIG. 1.

The server list table 210 contains list information which relates the business name and service name to an identification number of a network card mounted on each managed server 103, VLAN information as network segment information, and an IP address which is a logical network address assigned to the network card via VLAN.

As shown in FIG. 7, the server list table 210 is constituted of fields for a server name 701 of the managed server 103, an identification number (MAC address) 702 of the server having the server name 701, a business name 703, a service name 704, a VLAN name 705, an IP address 706 assigned to the server, and server location identification information (slot ID) 707.

The server identification number 702 is an identifier to be used for uniquely identifying each managed server 103 (refer to FIG. 1) which transmitted an address assignment request to be described later, and is mainly used by the network allocation server 102 (refer to FIG. 1). For example, the server identification number 702 may be a MAC address of an Ethernet (registered trademark) card or the like which is hardware identification information on the network card of the server. In the following, a MAC address is used as an example of a server identification number.

The server location identification information 707 is identification information for uniquely identifying each server, and is used for uniquely identifying each record of the server list table 210. For example, the server location identification information 707 may be a combination of an identifier of a chassis accommodating blade servers and a slot number in the chassis, or the like. For example, a blade having a chassis number of “1” and a slot number of “0” in the chassis can be represented by an identifier of “1-#0”. In the following, a combination of a chassis number and a slot number is used as an example of the server location identification information 707, and this combination is called a slot ID.

Each field of the server list table 210 is managed in correspondence with one slot ID 707. When the IP address 706 corresponding to the MAC address 702 is to be referred to, first the slot ID 707 corresponding to the MAC address 702 is referred, and then the IP address 706 corresponding to the slot ID 707 is referred to obtain the corresponding IP address.

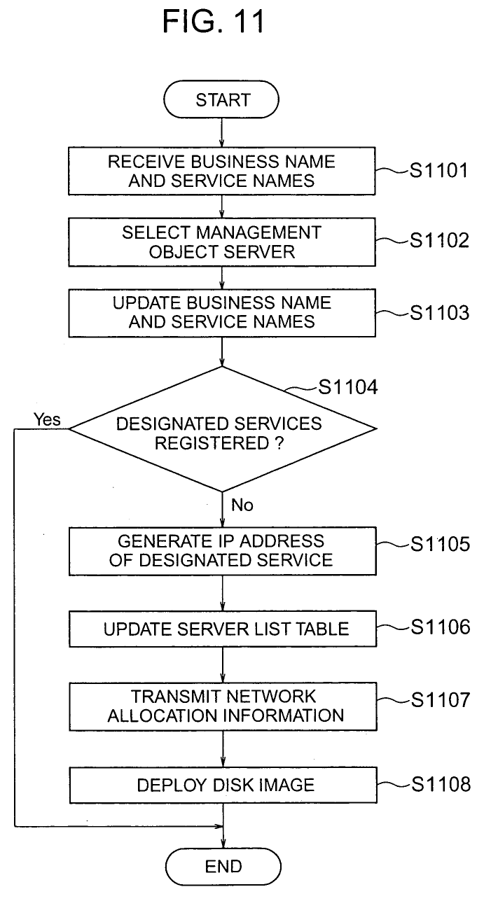

If the slot ID 707 is used for each corresponding field, and if hardware of the managed server 103 becomes defective and is replaced with new hardware, the managed server 103 after replacement has the same slot ID 707 before replacement. It is therefore possible to inherit information on the IP address of the managed server 103 before replacement. After the hardware of the managed server 103 is replaced, the MAC address 702 corresponding to the slot ID is registered again by using a method of generating the MAC address 702 to be described later. Thereafter, Steps S1107 and S1108 shown in FIG. 11 to be described later are executed so that the present invention can be applied to failure recovery from replacement of the managed server 103.

Whether replacement is caused by failure occurrence can be judged by referring to a status field 708. The status field 708 indicates the present status of the managed server 103. The status field stores, for example, information on a normal status, a failure occurrence, replacement standby due to failure occurrence and the like. Adopting failure recovery can be realized by replacement of the blade corresponding to the slot ID in the status of replacement standby due to failure occurrence.

As an example of the method of generating the server name 701, MAC address 702 and slot ID 707 of the managed server 103, the server management server 101 stores beforehand necessary information in an apparatus (not shown) for collectively managing MAC addresses of managed servers 103, the apparatus is inquired at the time of initial system configuration to acquire the information on the slot ID (server location identification information), server name and MAC address, and an operation administrator updates the server list table 210 registered in the storage device via GUI or directly for explicit registration.

In an alternative method, at the time of initial system configuration, a configuration information collection program is transmitted to managed servers 103 to collect the information at the server management server 101 and to store it in the server list table 210 of the server management 101.

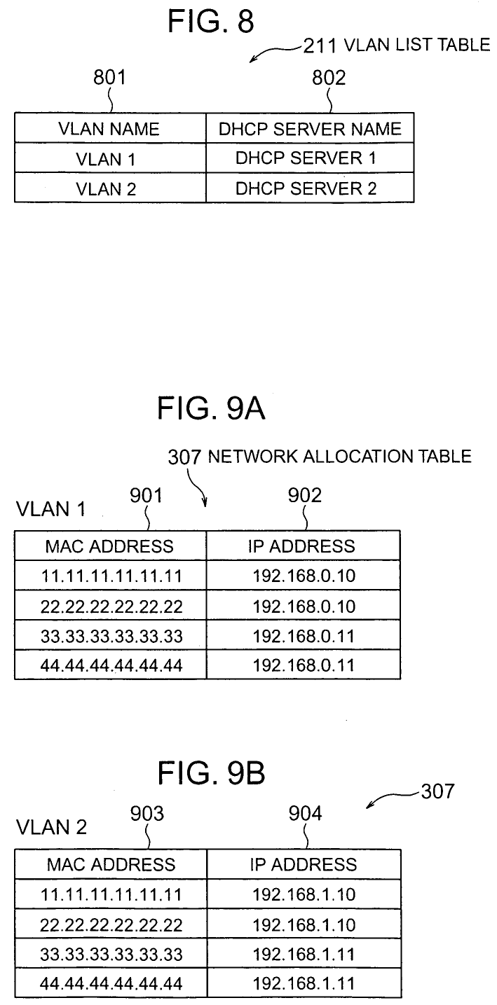

FIG. 8 is a diagram showing an example of the structure of the VLAN list table 211 provided in the server management server 101 of the operation management system of the first embodiment shown in FIG. 1.

If the server management server 101 and network allocation server 102 are implemented by different programs and the programs are executed on different computers, the VLAN list table 211 stores a list of correspondences between VLANs (network segments) in the operation management system managed by the server management server 101 and network allocation servers 102 belonging to VLANs.

If the server management server 101 and network allocation server 102 are implemented by different programs and the programs are executed on the same computer, or if the server management server 101 and network allocation server 102 are implemented by the same program, an identification number of a network card possessed by the computer on which the server management server 101 operates and belonging to the VLAN is stored in the field of the VLAN list table 211 having the network allocation server 102.

If the server management server 101 and network allocation server 102 are implemented on different computers and a plurality of network allocation servers 102 are implemented on the same computer, the identification number of the network card belonging to VLAN is stored.

As shown in FIG. 8, the VLAN list table 211 is constituted of fields for a VLAN name 801 and a DHCP server name 802 of the network allocation server belonging to VLAN. As will be later described, the VLAN list table 211 is registered when the operation administrator configures the system.

FIGS. 9A and 9B are diagrams showing examples of the structure of the network allocation table 307 provided in the network allocation server 102 of the operation management system 1 of the first embodiment shown in FIG. 1. FIG. 9A shows the table for VLAN 1 as a network segment N, and FIG. 9B shows the table for VLAN 2 as a network segment N. When an address assignment request for the network interface card is received from the managed server 103, the network allocation server 102 refers to the network allocation table 307 to determine and return the IP address to be used by the network interface.

The network allocation table 307 is constituted of fields for MAC addresses 901 and 903 for uniquely identifying the network card (communication device (403) mounted on the managed server 103 and IP addresses 902 and 904 to be assigned to the MAC addresses.

Detailed description will be made on a method of automatically assigning an IP address of the managed server 103, to be executed by the server management server 101 of the first embodiment, by showing examples of process flows and table structures.

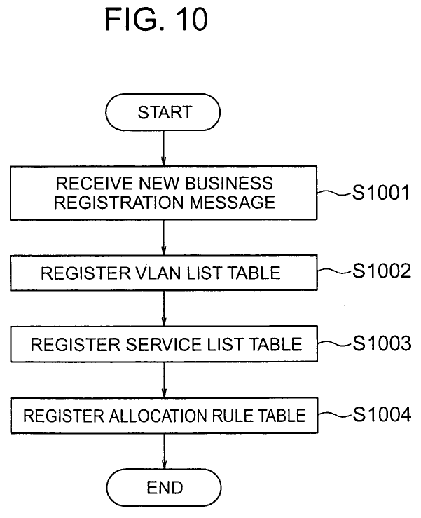

FIG. 10 is a diagram showing an example of a process flow of initializing the tables stored in the storage device, to be executed by the processing unit of the server management server 101, prior to automatic assignment of an IP address of the managed server 103 by the server management server 101 to be described later.

With reference to FIGS. 1 and 2, description will be made on a process of initializing the tables stored in the storage device of the server management server 101 of the first embodiment, along with FIG. 10.

When business provided by the managed server 103 of the first embodiment is to be changed, an operation administrator transmits a new business registration message to the server management server 101 from the operation administrator terminal under the management network segment. The processing unit of the server management server 101 receives the new business registration message along with business information (S1001). The business information contains a name of business to be newly registered, a list of services necessary for the business, VLAN names corresponding to the services, a name of a network allocation server (DHCP server name) corresponding to each VLAN, and an allocation rule. In one method of designating the business information, an operation administrator activates from the operation administrator terminal a program added with a function of transmitting a new business registration message and a function of registering new business, and the business information is designated via GUI.

Next, the server management server 101 registers VLAN names and corresponding network allocation server names (DHCP server names) among the business information in the VLAN list table 211 (refer to FIG. 8) (S1002).

Of the business information, the business name, a list of service names and system disk image storage locations are registered in the service list table 209 (refer to FIG. 6) (S1003).

If the disk image storage location is registered by storing the contents (disk images) of the storage device of the managed server 103 set up beforehand at the time of initial configuration in the service list table 209 of the server management server 101, by using a dedicated backup program (not shown), then it is checked whether disk image storage locations are registered in the list of the designated business name and service names. If not registered, an error message may be displayed on the operation administrator terminal to terminate the process.

For the business name and service names registered in the service list table 209, the VLAN names in the business information and an address candidate list are registered in the allocation rule table 208 (refer to FIG. 5) (S1004).

FIG. 11 is a diagram showing an example of a flow illustrating a process of setting up the managed server 103, including automatic assignment of an IP address, to be executed by the server management server 101. With reference to FIGS. 1 and 2, description will be made on the process of setting up the managed server 103 of the first embodiment, including automatic assignment of an IP address, along with FIG. 11. The server management server 101 receives directly or indirectly from the operation administrator an instruction of executing setup of the business/services provided by the managed server 101.

The operation administrator transmits an instruction of executing setup of the managed server 103, indirectly from the operation administrator terminal under the management network segment to the server management server 101, or directly from a terminal of the server management server 101. The processing unit of the server management server 101 receives the instruction together with the business name and service names (S1101).

In this case, one of the business name and service name may be made optional. If the service name is omitted, S1103 to S1108 are repeated for all services of the business having the designated business name. The following description assumes that the operation administrator inputs both the business name and service names.

The processing unit of the server management server 101 selects the managed server 103 which executes setup including automatic assignment of an IP address. Selection of the managed server 103 is performed by an input by the operation administrator to the operation administrator terminal under the management network segment or to the terminal of the server management server 101. As identification information for designating the managed server 103, the slot ID 707 (refer to FIG. 7) or the server name 701 corresponding to the slot ID 707 is used (S1102).

The processing unit searches from the server list table 210 (refer to FIG. 7) a record which corresponds to the managed server 101 selected at S1102 and the business name and service names received at S1101. If the corresponding record does not exist, the business name and service names received at S1101 are set to the record of the server list table 210 corresponding to the managed server selected at S1102 to update the table (S1103).

The processing unit judges whether the corresponding record exists, i.e., whether the designated business/services are registered in the server list table 210 (refer to FIG. 7) (S1104). If it is judged that the record does not exist (No at S1104), the processing unit continues to execute S1105, whereas if exists (Yes at S1104), the processing unit of the server management server 101 terminates the process.

By using the managed server 103 selected at S1102 and the business name and service names received at S1101 as a search key, the network setting generation unit 206 in the processing unit searches the allocation rule table 208 (refer to FIG. 5) to acquire the corresponding VLAN name 503 and address candidate list 504 and acquire the range of IP addresses to be assigned to each VLAN. Next, by using the business name and service names received at S1101, the server list table 210 (refer to FIG. 7) is referred to and an IP address 706 to be assigned to each VLAN 705 and not duplicated with the IP address registered in the server list table 210 is generated from the range of the address candidate list 504 (S1105). For example, if the name of the managed server 103 to be set up is “SV2”, a business name is “business 1” and a service name is “Web server”, the VLAN name and address candidate list are read from the server list table 208 (refer to FIG. 5) under the same conditions. Then, in accordance with the address candidate list for each VLAN name, an IP address “192.168.0.11” is determined which is not duplicated with the IP address “192.168.0.10” determined from the already registered server name “SV1”. Namely, S1105 generates the IP address of the designated service.

The network setting generation unit 206 updates the server list table 210 by setting the IP address for each VLAN name generated at S1105 to the record corresponding to the managed server 103 selected at S1102 and the business name and service names received at S1101 (S1106).

By using the business name and service names received at S1101, the network setting generation unit 206 refers to the server list table 210 to acquire the MAC address, VLAN name and IP address for each server name and set the MAC address and IP address for each VLAN name to a temporary area of the memory 202. In this case, however, since it is not possible to judge whether each MAC address belongs to which VLAN, all combinations of the MAC address and IP address are generated. As will be later described, the network allocation server 102 can identify a corresponding IP address even if any MAC address is received in response to an IP address assignment request from the managed server 103. The network setting generation unit 206 transmits the network allocation information constituted of the combinations of the MAC address and IP address for each VLAN name set to the temporary area, to the network allocation server 102 associated with the DHCP server name corresponding to the VLAN name in the VLAN list table 211 (refer to FIG. 8) (S1107).

If the network allocation server 102 and server management server 101 are implemented by different programs on the same computer, the server management server 101 acquires an identification number of the network card instead of the DHCP server name corresponding to the VLAN name in the VLAN list table 211, and transmits a combination of the network allocation information and a network identification number corresponding to the VLAN name, to the network allocation server 102 on the same computer.

If the server management server 101 and network allocation server 102 are implemented on different computers and if a plurality of network allocation servers 102 are implemented on the same computer, the server management server acquires an identification number instead of the DHCP server name corresponding to the VLAN name in the VLAN list table 211, and transmits a combination of the network allocation information and the network identification number corresponding to the VLAN name, to the network allocation server 102 on the different computer.

In the first embodiment, although the VLAN name is used as a fixed key, the embodiment is not necessarily limited thereto. For example, in the case of replacement due to blade failure occurrence, an identifier of the chassis mounting blade servers may be used as a fixed key. Namely, assignment of an IP address can be made flexible by changing the fixed key in accordance with use objects.

S1108 is executed for disk deploy of each managed server 103. It is possible to designate omission of S1108 in accordance with the process contents at Step S1602 to be described later. In this case, S1108 will not be executed. By using the business name and service names received at S1101, the disk image deploy unit 207 in the processing unit prepares a disk image to be set up. In preparing the disk image, the disk image deploy unit 207 refers to the service list table 209 (refer to FIG. 6) by using the business name and service names, to acquire the system disk image at the disk image storage location (disk image 603). The disk image deploy unit 207 executes a deploy process by transmitting to the managed server 103 the prepared disk image and an install program for writing the disk image in the storage device 404 of the managed server 103 to be set up and selected at S1102 (S1108). With these processes, an IP address can be automatically allocated to the business/services. Recovery from server failure can be made easy by using the slot ID 707 field and status 708 field shown in FIG. 7. Namely, if a blade failure occurs and the blade is replaced with a new one, the same IP address before failure can be assigned to a new blade even if the MAC address is changed to a new one, by setting a correspondence between an IP address and the new MAC address by using the slot ID 707 as the fixed key. This means that a correspondence between the MAC address and ID address can be released although the MAC address and IP address have conventionally been managed in one-to-one correspondence. Therefore, even in the case of blade failure, configuration change or the like, IP address assignment can be flexibly managed by separating it from the physical MAC address.

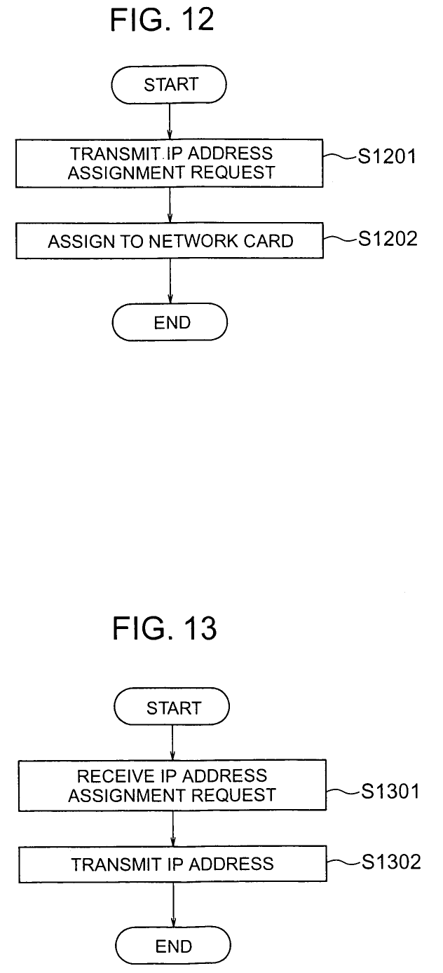

FIG. 12 is a diagram showing an example of a flow illustrating a process to be executed when the managed server 103 acquires an IP address assigned to the mounted network card. With reference to FIGS. 1 and 4, description will be made on a process to be executed when the managed server 103 acquires an IP address assigned to the mounted network card, along with FIG. 12.

The network setting acquisition unit 406 designates the MAC address of a network card to which an IP address is to be assigned, and transmits, via the VLAN (network segment N) to which the network card belongs, an IP address assignment request to the network allocation server 102 belonging to the same VLAN (S1201).

The network setting acquisition unit 406 assigns the IP address received from the network allocation server 102 to the network card (communication device 403) having the designated MAC address (S1202).

FIG. 13 is a diagram showing an example of a flow illustrating a process to be executed when the network allocation server 102 receives an IP address assignment request from the managed server 103 and returns a proper IP address. With reference to FIGS. 1 and 3, description will be made on the process to be executed when the network allocation server 102 receives an IP address assignment request from the managed server 103 and returns a proper IP address, along with FIG. 13.

The network setting allocation unit 306 in the processing unit receives an IP address assignment request added with a MAC address from the managed server 103 (S1301). The network allocation server 102 sets the received IP address assignment request together with the identification number of the network to a temporary area of the memory 302.

In one method of receiving the IP address assignment request and setting the IP address assignment request and the received network card identification number, an independent IP address assignment request reception function is operated beforehand in one-to-one correspondence with each network card, and when one reception function receives the IP address assignment request, the network card identification number corresponding to one reception function together with the IP address assignment request is set to the temporary area of the memory 302. An example of the reception function is a network socket of network communication programming.

If the server management server 101 and network allocation server 102 are implemented by different programs, the network setting allocation unit 306 refers to the network setting allocation table 307 by using the MAC address added at S1301, and transmits the corresponding IP addresses (S1302). However, if the server management server 101 and network allocation server 102 are implemented by different programs on the same computer, the network allocation server 102 refers to the network allocation table 307 corresponding to the network card identification number and set to the temporary area at S1301.

If the server management server 101 and network allocation server 102 are implemented by the same program, the network allocation server 102 refers to the VLAN list table 211 by using the network card identification number set to the temporary area at S1301, to identify VLAN via which the IP address allocation request was transmitted. By using the MAC address added at S1301 and VLAN, the network allocation server refers to the server list table 210 and transmits the corresponding IP address.

If the server management server 101 and network allocation server 102 are implemented on different computers and if a plurality of network allocation servers 102 are implemented on the same computer, the network allocation server 102 refers to the network allocation table 307 corresponding to the network card identification number set to the temporary area at S1301.

The IP address assignment request arrives, via the network card of the managed server 103 to which an IP address is assigned, at only the network allocation server 102 belonging to the same VLAN. Therefore, even if the request is added with the MAC address of any network card, the IP address to be assigned can be uniquely determined.

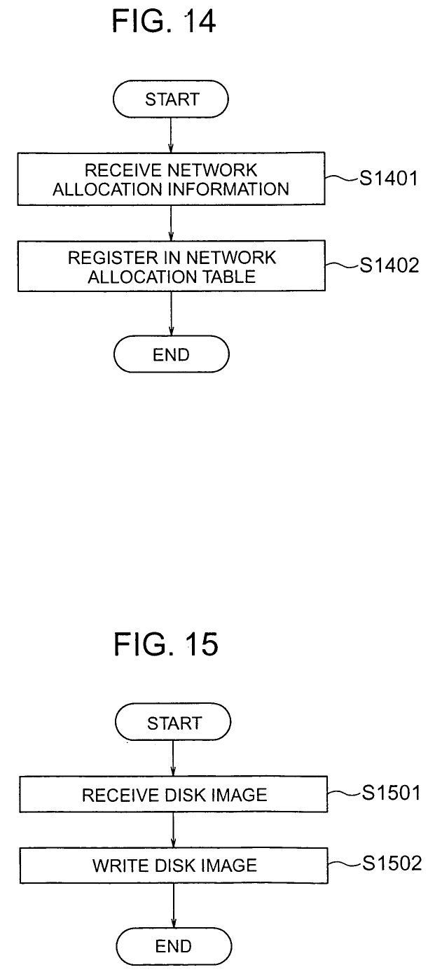

FIG. 14 is a diagram showing an example of a flow illustrating a process to be executed when the network allocation server 102 registers the MAC address and IP address received from the server management server 101 in the network allocation table 307. With reference to FIGS. 1 and 3, description will be made on the process to be executed when the network allocation server 102 registers the MAC address and IP address received from the server management server 101 in the network allocation table 307, along with FIG. 14. If the server management server 101 and network allocation server 102 are implemented by the same program, this process flow is not required to be executed.

The processing unit of the network allocation server 102 receives network allocation information from the server management server 101. The network allocation information is information on a pair of the MAC address and IP address (S1401).

If the network allocation server 102 and server management server 101 are implemented by different programs on the same computer, the network allocation information includes the network identification number in addition to the MAC address and IP address. This is also applicable if the server management server 101 and network allocation server 102 are implemented on different computers and a plurality of network allocation servers 102 are implemented on the same computer.

The processing unit registers the network allocation information in the network allocation table 307 (refer to FIG. 9) (S1402).

If the network allocation server 102 and server management server 101 are implemented by different programs on the same computer, a pair of the MAC address and IP address is registered in the network allocation table 307 corresponding to the network identification number. If the server management server 101 and network allocation server 102 are implemented on different computers and a plurality of network allocation servers 102 are implemented on the same computer, the similar operation is performed.

If a plurality of network allocation servers 102 are implemented on the same server or if the server management server 101 and network allocation server 102 are implemented on the same server, the network allocation information is registered in the network allocation table 307 for each VLAN.

FIG. 15 is a diagram showing an example of a flow illustrating a process to be executed when the managed server 103 receives a disk image from the server management server 101 and executes a deploy process. With reference to FIGS. 1 and 4, description will be made on the process to be executed when the managed server 103 receives a disk image from the server management server 101 and executes a deploy process, along with FIG. 15.

The disk image deploy processing unit 407 receives a disk image from the server management server 101 (S1501).

The disk image deploy processing unit 407 writes the disk image received at S1501 in the storage device 404 (S1502).

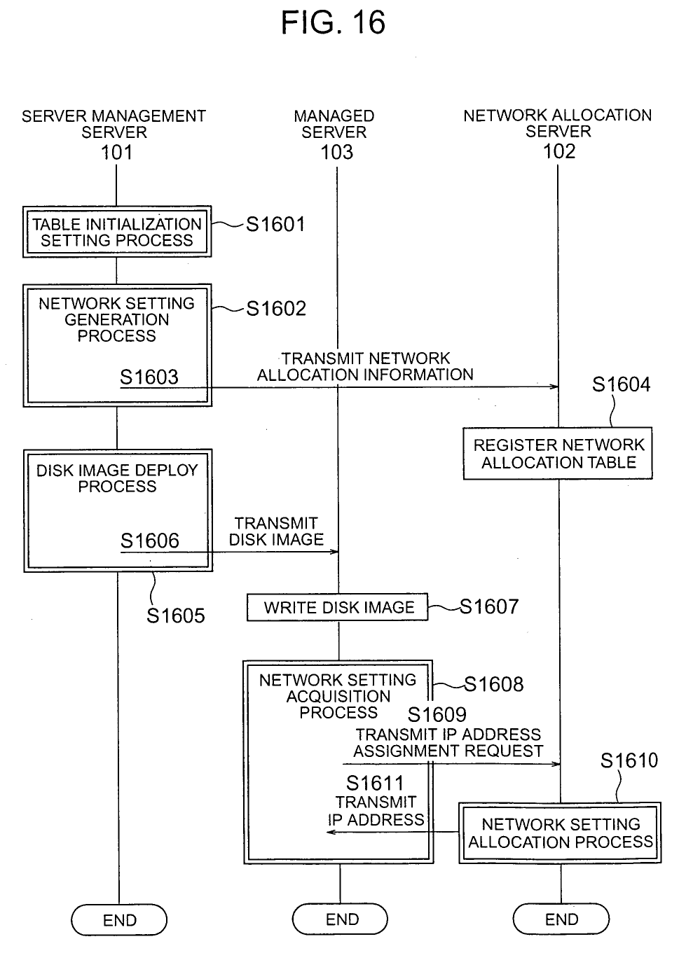

FIG. 16 is a diagram showing an example of a time chart illustrating the whole process of automatically assigning an IP address of the managed server 103 of the operation management system 1 of the first embodiment of the present invention. With reference to FIG. 1, description will be made on the time chart illustrating a method of automatically assigning an IP address of the managed server 103, along with FIG. 16.

The server management server 101 executes a table initialization setting process (S1601) (refer to FIG. 10) of initializing tables necessary for automatic assignment of an IP address of the managed server 103.

The server management server 101 executes a network setting generation process (S1602) (refer to FIG. 11) to assign IP address to one or more network interface cards which are constituent elements of the managed servers 103. The managed server 103 to be set up is determined by an input from a user terminal at S1602. In this network setting generation process, an IP address for each of the business/services is generated, and the network allocation information (MAC address and IP address) is transmitted to the network allocation server 102 (S1603).

At an event of receiving the network allocation information, the network allocation server 102 registers the network allocation information in the network allocation table 307 (S1604) (refer to FIG. 14).

After the network setting generation process (S1602), in order to set up each managed server 103 assigned the IP address at S1603 and to provide the business/services, the server management server 101 executes a disk image deploy process (S1605) (refer to FIG. 11). Disk deploy is independent from other steps, and may be performed before S1601 manually by an operation administrator or by a method other than that described in the first embodiment. If the disk deploy is performed before S1601 by a method other than the deploy method of the first embodiment, Step 1606 is omitted. In one designation example for deploy omission, a check item “no execution of deploy” is displayed on the user terminal when S1102 is executed, and if this check is selected, the deploy process is omitted.

In the disk image deploy process, a disk image for each of the business/services is transmitted to the managed server 103 (S1606).

At an event of receiving the disk image, the managed server 103 writes the received disk image in the storage device 404 (refer to FIG. 4) (S1607) (refer to FIG. 15).

In order to actually assign an IP address for each of the business/services to be provided, the managed server 103 executes a network setting acquisition process (S1608) (refer to FIG. 12). In the network setting acquisition process, in order to assign an IP address to a network card to be used for the business/services, an IP address assignment request added with a MAC address of the network card is transmitted to the network allocation server 102 (S1609).

At an event of receiving the IP address assignment request, the network allocation server 102 executes a network setting allocation process (S1610) (refer to FIG. 13) to assign an IP address corresponding to the added MAC address. In the network setting allocation process, the assigned IP address is transmitted to the managed server 103 (S1611).

The network setting acquisition process (S1608) by the managed server 103 is terminated when the IP address is assigned to the network card.

As described above, according to the first embodiment, when a setup instruction for the business/services to be provided by the managed server 103 is received from an external, the server management server 101 deploys the managed server by using the received business name and service names, and registers all MAC addresses in the network allocation server 102 connected to each VLAN (network segment N) belonging to the business. Accordingly, when a MAC address is transmitted from the managed server 103, it is possible to ensure that the IP address corresponding to the business is assigned to a particular network card (communication device 403). Since an identification number (MAC address) of a physical network card, a network segment N (VLAN) and a logical network address (IP address) belonging to the network card can be automatically assigned even if the business of the managed server 103 changes frequently, a work load of an operation administrator can be reduced considerably and setting miss can be suppressed from being generated.

### Second Embodiment

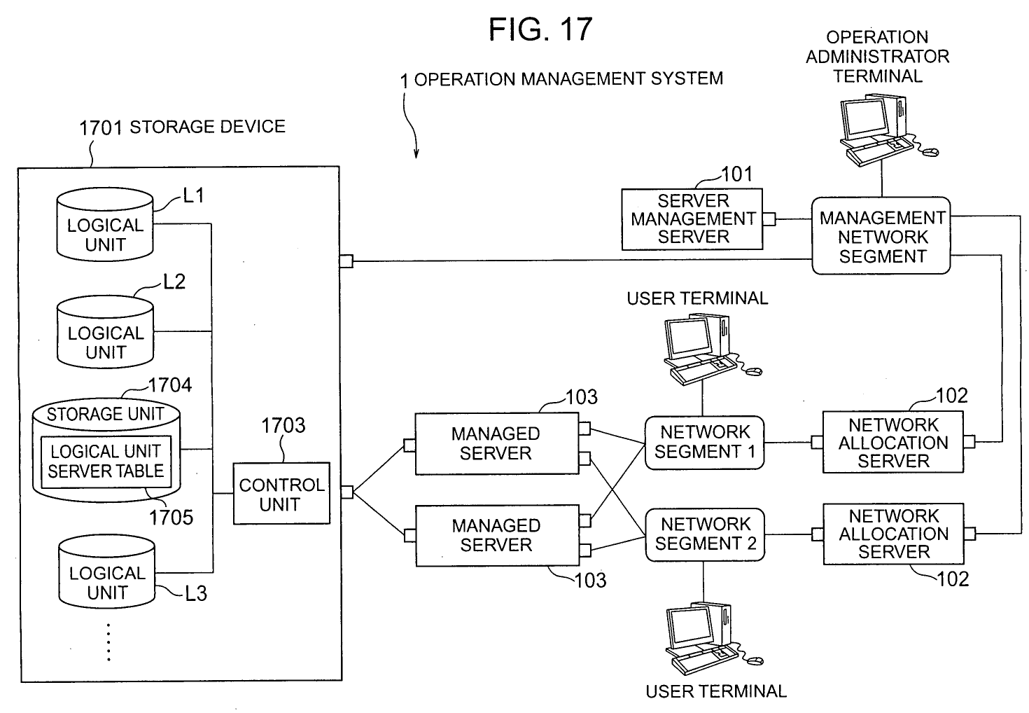

FIG. 17 is a diagram showing an example of a configuration of an operation management system according to the second embodiment of the present invention.

As shown in FIG. 17, the second embodiment is different from the first embodiment shown in FIG. 1 in that each managed server 103 is connected to an external storage device 1701 via an interface such as a network card and a host bus adaptor (HBA) of FibreChannel. The main object of the second embodiment is to change a system configuration on the assumption that the system initial configuration is already performed.

The storage device is constituted of a control unit 1703 and a storage unit 1704. The storage unit 1704 stores a logical unit server table 1705. The storage device has therein at least one logical unit (LU) L1, L2 and L3. The logical units L1 to L3 are distinguished by identifiers unique in the storage device. An example of the identifier is a logical unit number (LUN) or the like.

The control unit 1703 of the storage device controls an access from the managed server 103 to the logical units L1 to L3. Namely, a particular logical unit LN is controlled to allow an access from only a designated managed server 103, in accordance with an access restriction table defined in the logical unit server table 1705. The details of the access control are disclosed in JP-A-2006-92562.

The logical unit server table 1705 stores a combination between identifiers of the managed servers 103 and the logical units L1 to L3. An access is permitted only between the managed server 103 and logical unit designated by the table.

An example of the server identifier is a

World Wide Name (WWN) used by FibreChannel or the like. Namely, the server management server 101 accesses the storage device 1701 via a management network and can rewrite the logical unit server table 1705.

In the second embodiment, the table includes fields for an identifier (WWN) of the managed server 103 and an identifier of a designated logical unit or no identifier, in addition to the fields of the server list table 210 shown in FIG. 7. The identifier of the managed server is registered beforehand by an operation administrator. The logical unit identifier is registered in the table when a disk path switch to be described later is conducted.

In the second embodiment, at least one logical unit is allocated beforehand to each of the business/services, and OS and business applications are set up in the logical unit.

In allocating a disk to the managed server 103, the managed server 103 rewrites the logical units L1 to L3 accessible for the business/services in the logical unit server table 1705. This operation is called a disk path switch.

The disk images 603 in the service list table 209 shown in FIG. 6 become a list of identifiers of at least one logical unit.

In the second embodiment, a disk path switch operation is performed in the following manner, instead of the disk image deploy process (S1108) shown in FIG. 11.

By using the business name and service name received at S1101, a list of logical unit identifiers is acquired from the disk images 603 in the service list table 209 (refer to FIG. 6).

By referring to all managed servers 103 in the server list table 210 (refer to FIG. 7), a logical unit identifier, which is not referred to the field of WWN of the server list table 210, i.e., has no correspondence with all managed servers 103, is acquired from the list of acquired logical unit identifiers.

If there is no logical unit identifier having no correspondence with all managed servers 103, the disk path switch fails.

If at least one logical unit identifier is acquired which has no correspondence with the selected managed server 103, an arbitrary logical unit identifier is selected, and a pair of the selected logical unit identifier and the managed server 103 selected at S1102 is registered in the logical unit server table 1705 in the storage device 1701. In this case, if a pair of the selected managed server 103 and the logical unit identifier different from the selected logical unit identifier is already registered in the table, the logical unit field included in the pair registering the identifier of the managed server 103 is overwritten by the selected logical unit identifier.

The server management server 101 issues an activation notice or a re-activation notice to the managed server 103 selected at S1102. In one example of issuing the activation notice, a specific packet is transmitted to the network card of the managed server 103, and the management server 103 received the packet activates the server (this method is called Wake-On-Lan technology).

In one example of issuing the re-activation notice, a dedicated program is loaded in the memory 402 (refer to FIG. 4) of the managed server 103 selected at S1102, the server management server 101 transmits the re-activation instruction to the program via the network, and the program in the managed server 103 received the instruction re-activates the managed server 103.

The activated or re-activated managed server 103 does not execute the disk image deploy process 407 (refer to FIG. 4) shown in FIG. 15 and described in the first embodiment.

In the second embodiment, if all disks set up beforehand for the business/services are allocated to the managed servers 103, remaining managed servers 103 cannot provide the business/services, resulting in an operation restriction. However, when disks are allocated, a disk image is not required to be written when disks are allocated and only the field of the logical unit server table is updated. An allocation work can therefore be completed at high speed. The business/services can be changed at high speed when the business/services of the managed server 103 are to be changed in the second embodiment.

It should be further understood by those skilled in the art that although the foregoing description has been made on embodiments of the invention, the invention is not limited thereto and various changes and modifications may be made without departing from the spirit of the invention and the scope of the appended claims.

1. An operation management method for an operation management system including a plurality of managed computers having a plurality of network connections and an operation management apparatus for managing said managed computers, wherein:
said operation management apparatus stores a plurality of pieces of first allocation information representative of a correspondence among at least business or service, network segments and logical addresses of networks, in a storage device; and
when an instruction of setup for at least business or service provided by each managed computer is received from an external,
said operation management apparatus generates a correspondence between said plurality of pieces of first allocation information and a plurality of pieces of second allocation information representative of a correspondence between said managed computers and a physical address of each of said network connections.

2. The operation management method according to claim 1, wherein said operation management apparatus generates a correspondence among location identification information on said plurality of managed computers, said plurality of pieces of second allocation information and said plurality of pieces of first allocation information.

3. The operation management method according to claim 1, wherein in response to a logical address assignment request from said managed computer, said operation management apparatus determines a logical address in accordance with said correspondence among said plurality of pieces of second allocation information and said plurality of pieces of first allocation information, and transmits said logical address to said managed computer.

4. The operation management method according to claim 1, wherein:
said operation management system includes a network allocation computer for allocating the networks to said managed computers through communication between said managed computers and said operation management apparatus;
said operation management apparatus generates network allocation information representative of a pair of a physical address and a logical address for each of said network segments in accordance with said correspondence among said plurality of pieces of second allocation information and said plurality of pieces of first allocation information, and transmits the said network allocation information to said network allocation computer; and
said network allocation computer receives said network allocation information, and in response to a logical address assignment request from said managed computer, determines a logical address in accordance with said network allocation information and transmits said logical address to said managed computer.

5. The operation management method according to claim 1, wherein in response to update of the service regarding said correspondence among said plurality of pieces of first allocation information, and in accordance with disk image storage location information representative of a storage location of said disk image for execution of said service, said operation management apparatus assigns said disk image at said storage location to said managed computer.

6. The operation management method according to claim 4, wherein said network allocation computer is provided for each of said network segments to which said network connections of said managed computers belong.

7. The operation management method according to claim 4, wherein said network allocation computer is connected to said network segments to which said network connections of said managed computers belong.

8. The operation management method according to claim 4, wherein said operation management apparatus and said network allocation computer are a same computer.

9. An operation management method for an operation management apparatus in an operation management system including a plurality of managed computers having a plurality of network connections and said operation management apparatus for managing said managed computers, wherein:
said operation management apparatus stores a plurality of pieces of first allocation information representative of a correspondence among at least business or service, network segments and logical addresses of networks, in a storage device; and
when an instruction of setup for at least business or service provided by each managed computer is received from an external,
said operation management apparatus generates a correspondence between said plurality of pieces of first allocation information and a plurality of pieces of second allocation information representative of a correspondence between said managed computers and a physical address of each of said network connections.

10. The operation management method according to claim 9, wherein said operation management apparatus generates a correspondence among location identification information on said plurality of managed computers, said plurality of pieces of second allocation information and said plurality of pieces of first allocation information.

11. The operation management method according to claim 9, wherein in response to a logical address assignment request from said managed computer, said operation management apparatus determines a logical address in accordance with said correspondence among said plurality of pieces of second allocation information and said plurality of pieces of first allocation information, and transmits said logical address to said managed computer.

12. An operation management system including a plurality of managed computers having a plurality of network connections and an operation management apparatus for managing said managed computers, wherein said operation management apparatus comprises:
a storage device for storing a plurality of pieces of first allocation information representative of a correspondence among at least business or service, network segments and logical addresses of networks; and
a network setting generation unit for generating, when an instruction of setup for at least business or service provided by each managed computer is received from an external, a correspondence between said plurality of pieces of first allocation information and a plurality of pieces of second allocation information representative of a correspondence between said managed computers and a physical address of each of said network connections.

13. An operation management apparatus in an operation management system including a plurality of managed computers having a plurality of network connections and the operation management apparatus for managing said managed computers, wherein said operation management apparatus comprises:
a storage device for storing a plurality of pieces of first allocation information representative of a correspondence among at least business or service, network segments and logical addresses of networks; and
a network setting generation unit for generating, when an instruction of setup for at least business or service provided by each of said managed computers is received from an external, a correspondence between said plurality of pieces of first allocation information and a plurality of pieces of second allocation information representative of a correspondence between said managed computers and a physical address of each of said network connections.

14. A computer-readable operation management program to run on an operation management system including a plurality of managed computers having a plurality of network connections and an operation management apparatus for managing said managed computers, wherein said operation program operates that:
said operation management apparatus stores a plurality of pieces of first allocation information representative of a correspondence among at least business or service, network segments and logical addresses of networks, in a storage device; and
when an instruction of setup for at least business or service provided by each managed computer is received from an external,
said operation management apparatus generates a correspondence between said plurality of pieces of first allocation information and a plurality of pieces of second allocation information representative of a correspondence between said managed computers and a physical address of each of said network connections.

15. The computer-readable operation management program according to claim 14, wherein said operation management apparatus generates a correspondence among location identification information on said plurality of managed computers, said plurality of pieces of second allocation information and said plurality of pieces of first allocation information.

16. The computer-readable operation management program according to claim 14, wherein in response to a logical address assignment request from said managed computer, said operation management apparatus determines a logical address in accordance with said correspondence among said plurality of pieces of second allocation information and said plurality of pieces of first allocation information, and transmits said logical address to said managed computer.

17. The computer-readable operation management program according to claim 14, wherein:
said operation management system includes a network allocation computer for allocating the networks to said managed computers through communication between said managed computers and said operation management apparatus;
said operation management apparatus generates network allocation information representative of a pair of a physical address and a logical address for each of said network segments in accordance with said correspondence among said plurality of pieces of second allocation information and said plurality of pieces of first allocation information, and transmits the said network allocation information to said network allocation computer; and
said network allocation computer receives said network allocation information, and in response to a logical address assignment request from said managed computer, determines a logical address in accordance with said network allocation information and transmits said logical address to said managed computer.

18. The computer-readable operation management program according to claim 14, wherein in response to update of the service regarding said correspondence among said plurality of pieces of first allocation information, and in accordance with disk image storage location information representative of a storage location of said disk image for execution of said service, said operation management apparatus assigns said disk image at said storage location to said managed computer.

19. The computer-readable operation management program according to claim 17, wherein said network allocation computer is provided for each of said network segments to which said network connections of said managed computers belong.

20. The computer-readable operation management program according to claim 17, wherein said network allocation computer is connected to said network segments to which said network connections of said managed computers belong.
